(19) United States
(12) Patent Application Publication
(10) Pub. No.: US 2017/0140410 A1
(43) Pub. Date: May 18, 2017

(54) Rewards-Based Gaming System

(71) Applicant: OTG Management, New York, NY (US)

(72) Inventors: Eric J. Blatstein, New York, NY (US); Manu Gambhir, Philadelphia, PA (US); Matt Rosen, Media, PA (US)

(21) Appl. No.: 15/202,219

(22) Filed: Jul. 5, 2016

Related U.S. Application Data
(60) Provisional application No. 62/255,605, filed on Nov. 16, 2015.

(51) Int. Cl. G06Q 30/02; G07F 17/32

(52) U.S. Cl. CPC G06Q 30/0209; G07F 17/3255; G07F 17/3225; G07F 17/3209; G07F 17/3295

(57) ABSTRACT

A rewards-based gaming system includes, in some embodiments, a gaming server, a rewards server, and a database server and integrates with the existing food or merchandise sales system of a business establishment. Patrons of the business have the opportunity to play a game, on an appropriately configured computing device, from a selection of games. Playing a game provides the player-patron with a chance to win rewards points, which can be electronically redeemed for prizes, using the same computing device.

### STATEMENT OF RELATED CASES

This case claims priority to U.S. Pat. App. Ser. 62/255,605 dated Nov. 16, 2015 and is incorporated by reference herein.

### FIELD OF THE INVENTION

The present invention relates to incentive rewards systems and gaming systems.

### BACKGROUND OF THE INVENTION

Before smart phones and the iPad®, restaurant patrons occupied themselves while waiting for their meal by completing mazes and brain teasers on “game placemats” or by playing simple table games, such as “hang man,” “tic-tac-toe,” or “football.” Of late, parents keep their children occupied at the restaurant table with electronic games, such as can be played on tablet computers.

Although game placemats and electronic games help to pass the time, they do nothing to build a business establishment's brand or promote patronage thereof.

### SUMMARY OF THE INVENTION

The present invention provides a rewards-based gaming system for use in conjunction with a variety of businesses, such as restaurants, hotels, casinos, merchandise-sales establishments, etc. The system promotes patronage of such businesses by providing customers with a fun, engaging experience where they can win or earn items typically offered for sale at such establishments.

In accordance with the illustrative embodiment, the rewards-based gaming system integrates with the existing food or merchandise sales system of the business establishment. Integration requires relatively minor changes to the venue's existing sales system. Patrons of the business have the opportunity to play a game, on an appropriately configured computing device such as a tablet computer (e.g., Apple iPad®, Samsung Galaxy Tab models, etc.), from a selection of games. Playing a game provides the player-patron with a chance to win digital loyalty currency, referred to herein as “rewards points.” The rewards points can be electronically redeemed for prizes via the same computing device.

If a prize is in the form of food, drink, or merchandise, it can delivered to the player-patron with minimal delay (c.a., 15 to 30 minutes) based on the location of the computing device in the business establishment. If the prize is a discount or coupon that is to be applied to a regular purchase through the business' sales system, it can be delivered to the player-patron's computing device virtually instantaneously via an email, SMS, etc.

In the illustrative embodiment, the rewards-based gaming system includes a gaming server, a rewards server, and a database server.

In some embodiments, the gaming server is a client-server system that runs all of the games that are made available for play. Games fall under any one of the following four legal categories of gaming:
Sweepstakes: games must be free to play, can be games of chance, and prizes having real cash value can be won.
Gambling: games require consideration to play, can be games of chance, and prizes having real cash value can be won.
Loyalty: games require consideration to play, can be games of chance, prizes having real cash value cannot be won. Prizes are earned based on volume of play.
Skill: Games require consideration to play, cannot be games of chance, and prizes having real cash value can be won.

The gaming server manages three types of currencies: tokens, game credits and reward points. Tokens are the currency used to play games of chance, game credits are purchased to play games of skill, and rewards points are the currency that is redeemed for prizes.

The rewards server performs tasks related to prizes, such as, among other tasks, maintaining an updated list of the prize inventory, the pricing of prizes, handling the prize claim process, and interfacing with the business establishment's sales system.

The database server is a repository of information required by the gaming and rewards server to run the gaming system. The database server provides the gaming and rewards servers with an ability to query and retrieve information stored in its databases. Such information, much of which is updated (such as by the gaming and rewards servers) includes, without limitation, player-patron account information, token, game credit, and rewards points balances, prize and claim information, game play history, and computing device information.

The rewards-based gaming system provides several different revenue generation models, depending, for example and among any other considerations, on which legal category of gaming is used. Some examples of revenue generation models include:
Advertising. Player-patrons can earn game credits by watching paid advertisements or games can be directly sponsored by advertisers.
Sales of Game Credits. In skill-based games, game credits can be sold directly.
Sales of Tokens. In gambling or loyalty games, tokens can be sold directly.
Increased Sales of Food/Merchandise. Tokens, game credits and/or rewards points can be given to player-patrons along with purchases of food or merchandise in order to drive more sales of same.

In an alternative embodiment, the rewards-based gaming system includes a gaming server, a rewards server, a database server, and one or more computing devices (e.g., tablet computers, etc.) running specialized gaming application software for playing games run by the gaming server.

In some embodiments, the owner/operator of the rewards-based gaming system is a third party that has no ownership or management interest in the business with which the gaming system is being used (e.g., restaurant, casino, etc.). In some other embodiments, the operator/owner of the rewards-based gaming system owns or operates the business with which the gaming system is being used. In yet some additional embodiments, the rewards-based gaming system is licensed to the business for use thereby.

### BRIEF DESCRIPTION OF THE DRAWINGS

FIG. 1A depicts rewards-based gaming system 100 in accordance with a first illustrative embodiment of the present invention being used by a patron of a business establishment.

FIG. 1B depicts rewards-based gaming system 100 in accordance with a second illustrative embodiment of the present invention being used by a patron of a business establishment.

FIG. 1C depicts rewards-based gaming system 100 in accordance with a third illustrative embodiment of the present invention being used by a patron of a business establishment.

FIG. 2 depicts a block diagram of the rewards-based gaming system 100 of FIGS. 1A through 1C.

FIG. 3 depicts a block diagram of an embodiment of a gaming server of the rewards-based gaming system.

FIG. 4 depicts a block diagram of an embodiment of a rewards server of the rewards-based gaming system.

FIG. 5 depicts a block diagram of an embodiment of a database server of the rewards-based gaming system.

FIG. 6 depicts a block diagram of a computing device for use in conjunction with the rewards-based gaming system.

FIG. 7 depicts contents of an information storage device of the gaming server of FIG. 3.

FIG. 8 depicts contents of an information storage device of the rewards server of FIG. 4.

FIG. 9 depicts contents of an information storage device of the database server of FIG. 5.

FIG. 10 depicts contents of an information storage device of the computing device of FIG. 6.

FIG. 11 depicts tasks performed by the rewards-based gaming system implementing a method in accordance with the present invention.

FIG. 12 depicts an illustrative screen shot of the computing device during game play.

### DETAILED DESCRIPTION

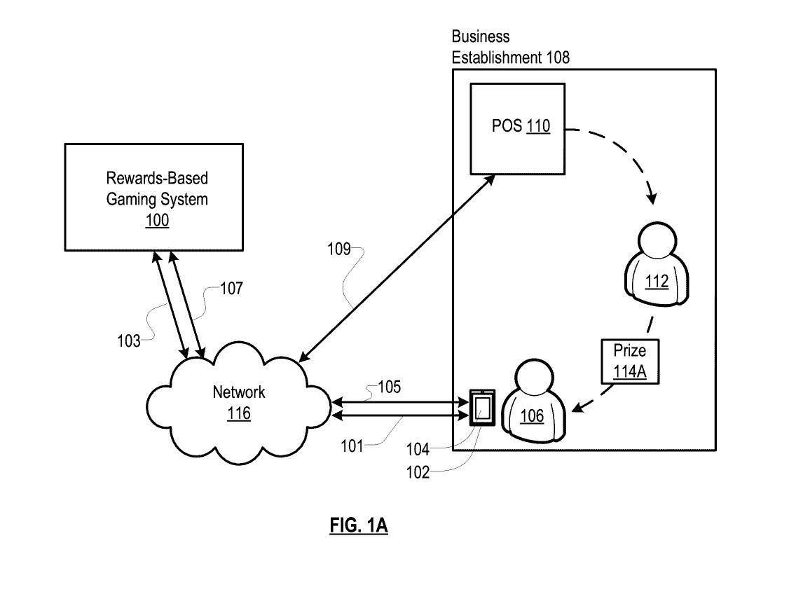

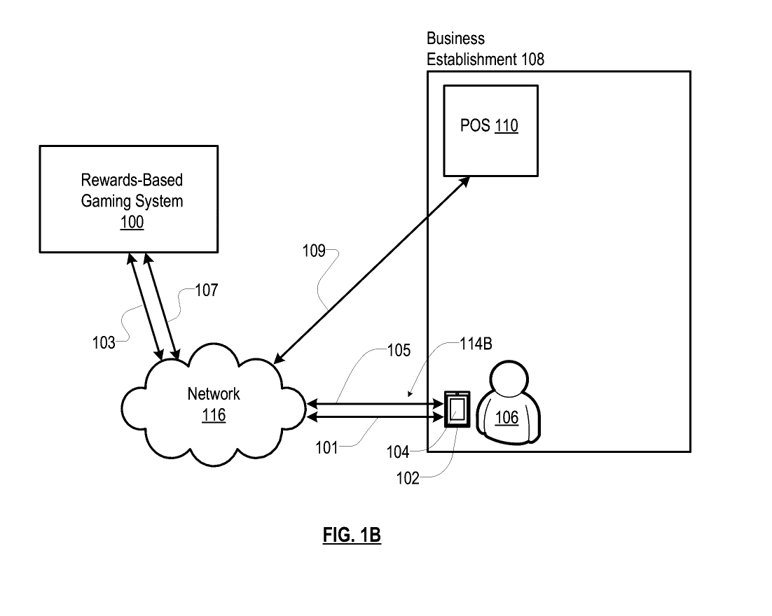

FIG. 1A depicts player-patron 106 in business establishment 108 using computing device 102 to play games available through rewards-based gaming system 100. Business establishment 108 includes point-of-sale system (“POS”) 110 and local service representative(s) 112. Gaming system 100, computing device 102, and POS 110 communicate with one another via wide area network 116, such as the Internet, among any other modes of communication.

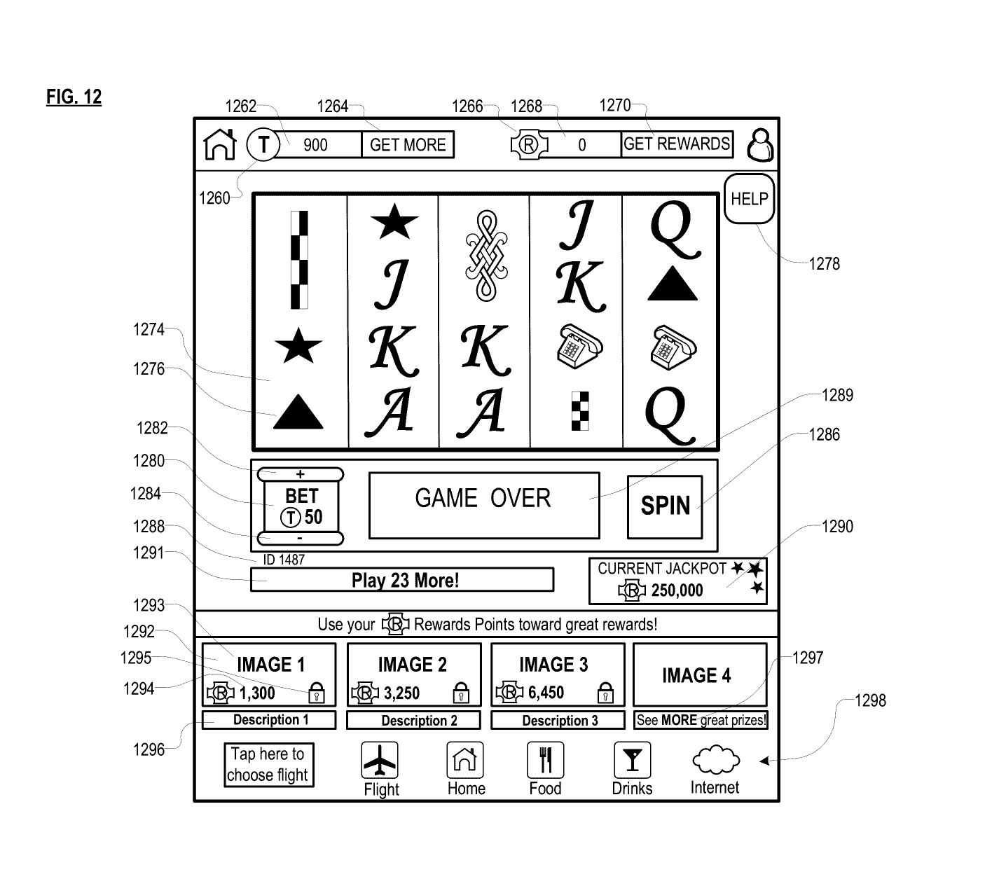

To play a game, player-patron 106 accesses a software application (“app”) on computing device 102. The application generates graphical user interface (“GUI”) 104 and causes it to be displayed in the display screen of computing device 102. GUI 104, unique for each game, presents to player-patron 106 the game's environment (e.g., for a slot machine: a representation of the reels, the symbols on the reels, etc.). The GUI is also the means by which player-patron 106 interacts with the game, such as via soft keys, to wager or make other game-related commands, etc. The GUI also displays the results of the player-patron's actions as well as status information, such as the amount of rewards points won/earned and the amount of available tokens or game credits. Additionally, GUI 104 presents prize options. An illustrative GUI 104 is described in further detail later in this specification in conjunction with FIG. 12.

Gaming system 100 handles the game logic; game play on computing device 102 requires bi-directional interactions with gaming system 100. The “gaming” interactions, supported for example by network 116, are represented by (logical) communication links 101 and 103.

When the game has ended, based on the outcome thereof, player-patron 106 might be awarded rewards points by gaming system 100. Player-patron 106 can use the rewards points to select a prize or chose to accumulate the rewards points over multiple games. The rewards points are electronic/digital; they are not physically manifested, such as being in the form of a coin, etc.

Gaming system 100 also manages the rewards and prize claiming process. The gaming system transmits prize options to computing device 102 for presentation, via GUI 104, to player-patron 106. The player-patron can then select one of the offered prizes consistent with the available amount of rewards points. The prize selection is transmitted from computing device 102 to gaming system 100. The rewards/prize claim interactions, supported for example by network 116, are represented by (logical) communication links 105 and 107.

In the scenario depicted in FIG. 1A, the prizes are goods that are offered by business establishment 108. Consider an embodiment in which the business establishment is a restaurant. In such an embodiment, the prizes being offered will typically be food or beverages. Gaming system 100 transmits the player-patron's prize selection to the business restaurant's POS 110 over (logical) communications link 109. Link 109 can be used to update gaming system 100 about changes in prize availability, etc. The POS causes the establishment's kitchen to prepare the prize selection/food request. When the food is ready, representative 112—in that scenario, a food server—picks up prize 114A (the food or drink) and delivers it to player-patron 106 at the location of computing device 102.

Consider an embodiment in which business establishment 108 is a seller of merchandise. In such an embodiment, the prizes being offered will typically be merchandise offered by the merchant. Gaming system 100 transmits the prize selection of player-patron 106 to the store's POS 110, which may then direct the stockroom, for example, to retrieve the player-patron's merchandise selection. In some embodiments, once the merchandise is made available, representative 112—in that scenario, a store clerk—picks up prize 114A (the merchandise) and delivers it to player-patron 106 at the location of computing device 102.

In the scenario depicted in FIG. 1A, the prize is physically manifested; that is, it is in the form of food, drink, merchandise, etc. There are other scenarios in which the prize is not physically manifested; rather, it is in electronic form. One such scenario is depicted in FIG. 1B.

The gaming interactions and prize-claiming interactions are essentially the same for the scenarios depicted in FIG. 1A and FIG. 1B. However, rather than selecting a physically manifested prize, player-patron 106 uses rewards points won/earned to select a discount or coupon that can applied to regular purchases from the business establishment. Thus, prize 114B, in the form of an electronic/digital discount or coupon, is transmitted to computing device 102.

In the scenarios depicted in FIG. 1A and FIG. 1B, the prize, whether physically manifested or in electronic form, is associated with the business establishment at which player-patron 106 is playing a game. That is, if the establishment is a restaurant, the prize could be, for example, either food offered by the restaurant or a discount that can be applied to food ordered at the restaurant. In some other scenarios, the prize is sourced from a third-party business establishment; that is, a business establishment other than the business establishment where player-patron 106 and computing device 102 are located. Such a scenario is depicted in FIG. 1C.

The gaming interactions and prize-claiming interactions are essentially the same for the scenario depicted in FIG. 1C as for the scenarios depicted in FIG. 1A and FIG. 1B. However, rather than transmitting the prize request of player-patron 106 to POS 110 of business establishment 108, the request is transmitted to POS 118 of a “third-party” business establishment 117 over (logical) communications link 111. A typical application for this scenario would be wherein the player-patron uses rewards points to obtain an electronic gift card from, for example, Amazon.com, Inc., a credit card company, etc. Thus, prize 114C, in the form of an electronic gift card, is transmitted from POS 118 to the player-patron's smart phone 119, for instance, via e-mail or SMS. As used herein and in the appended claims, the phrase “electronic form,” when referencing a prize, means a coupon, discount, gift card, etc., that is delivered electronically (e.g., to a cell phone, tablet, etc.), regardless of whether it is ultimately printed on paper, etc.

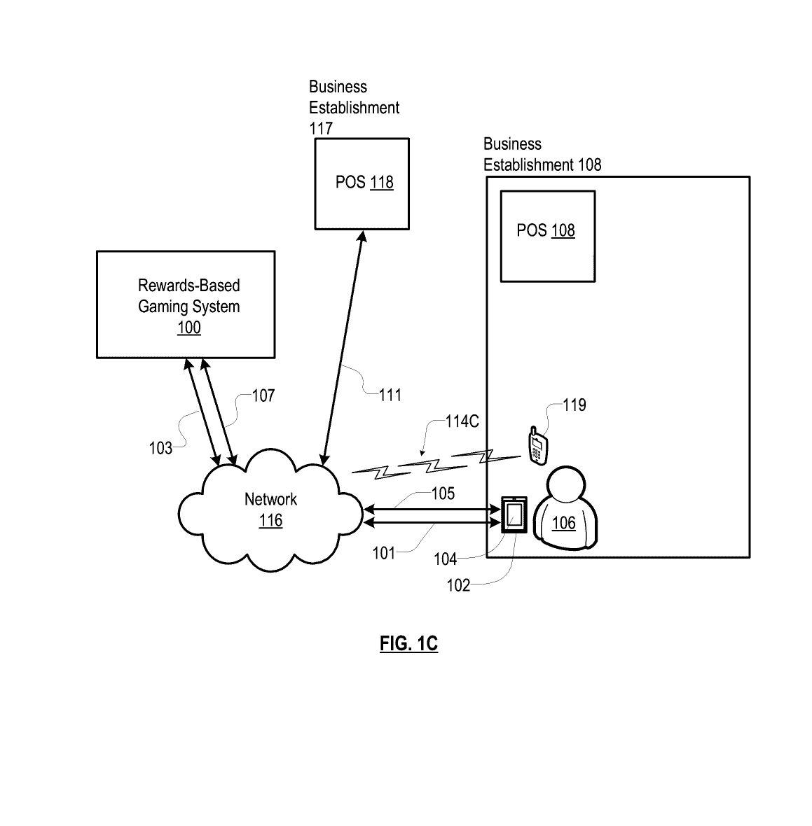

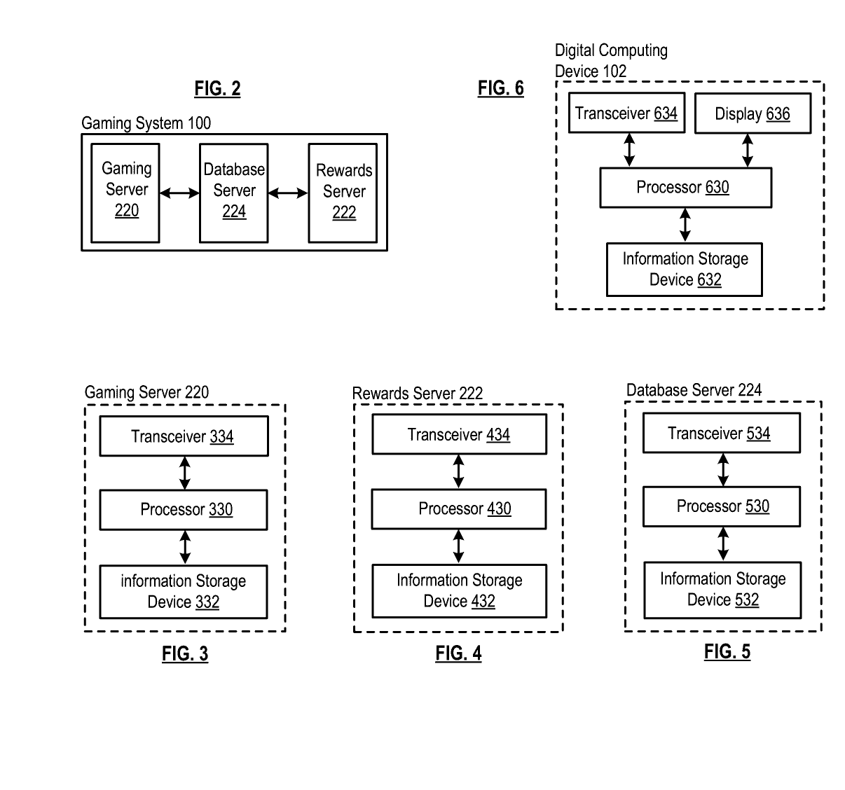

FIG. 2 depicts a block diagram of an embodiment of gaming system 100 in accordance with the present invention. As depicted, gaming system 100 includes gaming server 220, rewards server 222, and database server 224.

In the illustrative embodiment, gaming server 220 is a client-server system that runs all of the games that are made available for play. Gaming server 220 runs software that provides the game play logic and determines outcomes, in response to player-patron input, as submitted using computing device 102 (running client-side game software). The gaming server can run games from any of the four legal categories of gaming: sweepstakes, gambling, loyalty, and skill. In conjunction therewith, gaming server 220 manages three types of currencies: tokens, game credits and rewards points.

Tokens are used by a player-patron to play a game of chance. Tokens can be obtained in any one or more of the following ways: (1) purchasing them for cash for gambling or loyalty, only (not sweepstakes); (2) earning them by performing certain actions, such as, without limitation, signing up for an account on gaming system 100, watching an advertisement, taking a survey, or ordering food or merchandise; and (3) winning them based on game outcome (rewards points can be redeemed for tokens).

Game credits are used by a player-patron to play a game of skill. Game credits can be obtained in any one or more of the following ways: (1) purchasing them for cash; (2) earning them by performing certain actions, such as, without limitation, signing up for an account on gaming system 100, watching an advertisement, taking a survey, or ordering food or merchandise; and (3) winning them based on game outcome (rewards points can be redeemed for game credits).

Rewards points are redeemed for prizes. Rewards points can be obtained in any one or more of the following ways: (1) purchasing them for cash for all game types; (2) earning them by performing certain actions, such as, without limitation, signing up for an account, watching an advertisement, taking a survey, or ordering food or merchandise; (3) winning them based on game outcome, but for sweepstakes, gambling, or skill games only; and (4) earning them based on volume of play.

Rewards server 222 performs tasks related to managing the prizes that are available and managing the prize-claiming process. More particularly, rewards server 222 performs the following functions, by virtue of appropriate software, among any others:
(a) Prize Inventory and Pricing. Maintains an up-to-date list of all prizes that are available to the player-patrons and the cost of each such prize in rewards-points currency.
(b) Prize availability. Filters the list of available prizes for presentation to a player-patron based on one or more factors, including but not limited to:
   (i) player-patron location; and/or
   (ii) date or time of day; and/or
   (iii) player-patron rewards points balance; and/or
   (iv) demographic data about the player-patron.
(c) Prize claim process. Manages the prize claiming process, including:
   (i) enable the player-patron as well as customer service employees of the business establishment to view and/or update the status of outstanding prize claims;
   (ii) manage the collection of any additional information from the player-patron that might be necessary to fulfill the prize; and
   (iii) manage verification of player-patron eligibility for prizes having specific eligibility requirements.
(d) Prize drawings. This provides player-patrons that have only a small amount of rewards points a chance to win a large prize. For example, each entry into a prize drawing costs the player-patron only a small amount of rewards points. At a specified time and date, or once a specified number of entries have been made, a specified number of winners are chosen at random from all entries submitted. The winner(s) are notified by any available notification system and awarded the prize. If one or more winners do not respond within a specified time frame, replacement winners are selected.
(e) Interface with Sales system. Transmit information to venue food/merchandise sales system for handling prize fulfillment.

Database server 224 stores information required by gaming server 220 and rewards server 222 for operating the gaming system. The gaming and rewards servers are operable to query database server 224 for such information and database server is configured to be able to retrieve such information for use by the gaming and rewards servers. Furthermore, the information stored in the database server is updated on an on-going basis by gaming server 220 and rewards server 222.

FIGS. 3 through 5 depict block diagrams of the gaming server 220, rewards server 222, and database server 224. Each of these servers includes a processor (i.e., processors 330, 430, or 530), an information storage device (i.e., information storage devices 332, 432, or 532), and a transceiver (i.e., transceivers 334, 434, or 534).

Processors 330, 430, 530 are general-purpose processors that are capable of, among other tasks, executing an operating system, and executing specialized application software used in conjunction with the embodiments of the invention. Processors 330, 430, 530 are also capable of populating, updating, using, and managing data in respective information storage devices 332, 432, or 532. Furthermore, processors 330 and 430 are capable updating and accessing data stored in information storage device 532 of database server 224. In some alternative embodiments of the present invention, one or more of processors 330, 430, 530 are special-purpose processors. It will be clear to those skilled in the art how to make and use processors 330, 430, 530.

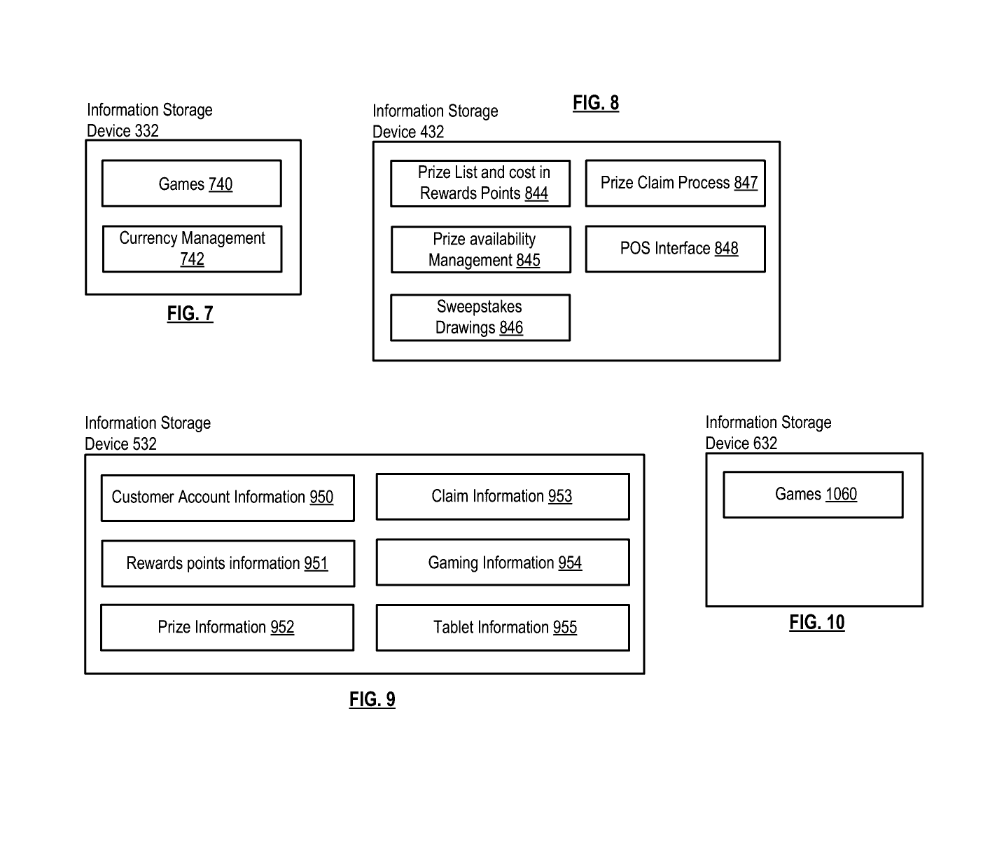

Information storage devices 332, 432, 532 are non-volatile, non-transitory memory technology (e.g., RAM, ROM, EPROM, EEPROM, hard drive(s), flash drive(s) or other solid state memory technology, CD-ROM, DVD, etc.) that store, among any other items, data and specialized application software, discussed further below in conjunction with FIGS. 7 through 9. When such software is executed, it enables processors 330, 430, and 530 to perform the features and tasks of the various embodiments of the invention. It will be clear to those skilled in the art how to make and use data-storage devices 332, 432, and 532.

Transceivers 334, 434, and 534 enable two-way communications with other devices and systems via any appropriate medium, including wireline and/or wireless, and via any appropriate protocol (e.g., Blue-tooth, WiFi, cellular, etc.). The term “transceiver” is meant to include any communications means and, as appropriate, various supporting equipment communications ports, antennas, etc. It will be clear to those skilled in the art, after reading this specification, how to make and use transceivers 334, 434, and 534.

FIG. 6 depicts a block diagram of computing device 102. The computing device includes processor 630, data storage device 632, transceiver 634, and display 636. The processor, data storage device and transceiver are adequately described by the foregoing description of processors 330, 430, and 530, information storage devices 332, 432, 532, and transceivers 334, 434, and 534, respectively. Display 636, typically LCD or LED based, presents information in visual form, in known fashion.

In the illustrative embodiment, computing device 102 is a “tablet” computer, such as, for example, an Apple iPad®, Samsung Galaxy Tab models, or the like. However, in some other embodiments, computing device 102 can take other forms, such as smart phone, lap-top computer, etc. The terms “computing device” and “tablet” are used interchangeably herein to refer to the client-side (gaming) device for use in conjunction with embodiments of the invention.

In each server 220, 222, and 224 (FIGS. 3-5) as well as tablet 102 (FIG. 6), the processor is in electrical communication with the data storage device and the transceiver. Each server and tablet includes, within its respective data storage device, one or more programs for controlling its respective processor. The processor performs the instructions of the program(s), thereby operating in accordance with embodiments of the present invention. Such programs are described in further detail later in this specification in conjunction with FIGS. 7-14.

FIGS. 7-10 depict contents of data storage devices 332, 432, 532, and 632. The contents thereof, as is germane to this disclosure, include specialized software applications as well as databases. It is to be understood that the specialized software applications, as presented in the figures, are “logical” entities in the sense that some or all of the functionality described as being associated with a particular module/application can be provided by any one or more of the other applications. Alternatively, all the functionality described for all the applications can be combined into a single specialized software application. The same is true of the databases.

FIG. 7 depicts data storage device 332 of gaming server 220. Among any other software or databases, data storage device 332 includes the following specialized application software: games module 740 and currency management module 742.

Games module 740 is software for running the games that are available for play on gaming system 100. This software provides the game logic that enables gaming server 220 to run the games that player-patrons are playing (on tablets, etc.) and to determine outcomes. Currency management module 742 manages tokens, game credit and rewards points. With respect to tokens and game credit, currency management module 742 enables processor 330 of gaming server 220 to:
check on a player-patron's token or game-credit balance to ensure that there is sufficient credit to play a game;
debit a player-patron's token or game credit balance as a consequence of play; and
provide a player-patron with options for obtaining additional tokens or game credit as required.
   As to obtaining additional tokens or game credit, currency management module 742 can cause processor 330 to, for example, query the player-patron whether they are willing to watch an advertisement or take a survey for credit and, if so, cause the advertisement or survey to be served to the player-patron's tablet.

Currency management module 742 also enables processor 330 of gaming server 220 to award rewards points, as appropriate, to a player-patron and credit their rewards points account balance, and to provide a player-patron with options for obtaining more rewards points. With respect to the former, the rewards points could be awarded, for example, based on game outcome (for sweepstakes, gambling, and skill games only) or based on the player-patron's volume of game play. As to obtaining additional rewards points, currency management module 742 can cause processor 330 to, for example, query the player-patron whether they are willing to watch an advertisement or take a survey for rewards points and, if so, cause the advertisement or survey to be served to the player-patron's tablet.

FIG. 8 depicts data storage device 432 of rewards server 222. Among any other software or databases, data storage device 432 includes the following specialized application software modules: prize list 844, prize-availability management 845, sweepstakes drawing 846, prize claim process 847, and POS interface module 848.

Prize-list module 844 is a list of prizes that are available for player-patrons to claim as prizes, along with the corresponding “cost” in rewards points. The list is, of course, unique to the particular business establishment with which gaming system is being used. Prize list module 844 is updated periodically to reflect changes in the business establishment's offerings and/or pricing. In some embodiments, updates occur electronically via communications between rewards server 222 and the POS of the business establishment. This requires that the POS is suitably configured for such communications. In some other embodiments, prize list module is updated by an email or SMS, sent from the business establishment to rewards server 222.

Prize-availability-management module 845 functions to filter the list of available prizes that are shown to any individual player-patron (i.e., transmitted, to the player-patron's tablet, for display). Filtering can be based on one or more of the following attributes:
Location of the player-patron;
Date or time of day;
The player-patron's current rewards points balance;
Any available demographic data about the player (e.g., age, prize selection history, etc.)

Sweepstakes-drawing module 846 enables processor 330 of rewards server 222 to offer certain prizes to the winner(s) of sweepstakes drawings. Entry into such a drawing costs a relatively small number of rewards points (e.g., a few hundred points, etc.). At a specified date and time, or once a specified number of entries have been received, a specified number of winners are chosen at random from all entries submitted.

Prize-claim-process module 847 enables processor 330 to manage the prize claim process, including, for example:
Enabling player-patrons and customer-service employees of the business establishment (that provides the prize) to view and/or update the status of outstanding prize claims;
Collecting any additional information from the player-patron that might be necessary to fulfill the prize request;
Verify a player-patron's eligibility for prizes they have claimed, to the extent such prizes have specific eligibility requirements.

POS-interface module 848 enables processor 330 (and hence rewards server 222) to interface with the POS of the business establishment that provides prize fulfillment, such as to transmit a prize order to the business establishment.

FIG. 9 depicts data storage device 532 of database server 224. Among any other software or databases, data storage device 532 includes the following databases: customer-account information 950, rewards-points data 951, prize data 952, prize-claim data 953, gaming data 954, and tablet information 955.

The databases in data storage device 532 of database server 224 are accessed by both gaming server 220 and rewards server 222 to update the databases and retrieve information therefrom.

Customer-account-information database 950 contains, among other information, the name, address, and other demographic information of anyone that has signed-up for an account with gaming system 100. It is notable that a player-patron does not need an account to play (i.e., they can play as a “guest”); however, without an account, any rewards points, tokens, or game credits accrued at the end of player-patron's gaming session will be lost.

Rewards-points database 951 includes rewards points balances for account holders and for guests (currently playing). Rewards-points database 951 also includes a history of rewards-points transactions for account holders and guests (currently playing). This database is regularly updated to reflect changes in account holders' balances, etc. Prize-information database 952 includes a list of prizes available for player-patrons to claim as prizes, with the corresponding “cost” in rewards points. The list is unique to the particular business establishment with which gaming system 100 is being used. Prize-information database 952 is updated periodically to reflect changes in the business establishment's offerings or pricing.

Claim-information database 953 includes historical information about the prizes that account holders have claimed. This database is regularly updated by rewards server 222. Gaming database 954 includes game-play information for each game, pay tables, and each account holders' (or guests') play history. Play history is regularly updated by gaming server 220. Tablet-information database 955 includes device information, including location, for each tablet or other device offered for game play by the business establishment.

FIG. 10 depicts data storage device 632 of tablet 102. Among any other software or databases, data-storage device 632 includes the following specialized application software: gaming module 1060. The gaming module includes software that enable processor 630 of tablet 102, etc., to display a user interface for each game offered for play by gaming system 100. In the illustrative embodiment, there is a separate software application for each game. The user interface for the game enables the player-patron to interact with gaming system 100, such as by transmitting appropriate input (e.g., tokens, game credits, a wager, required player actions, etc.) to gaming server 220 to play the selected game.

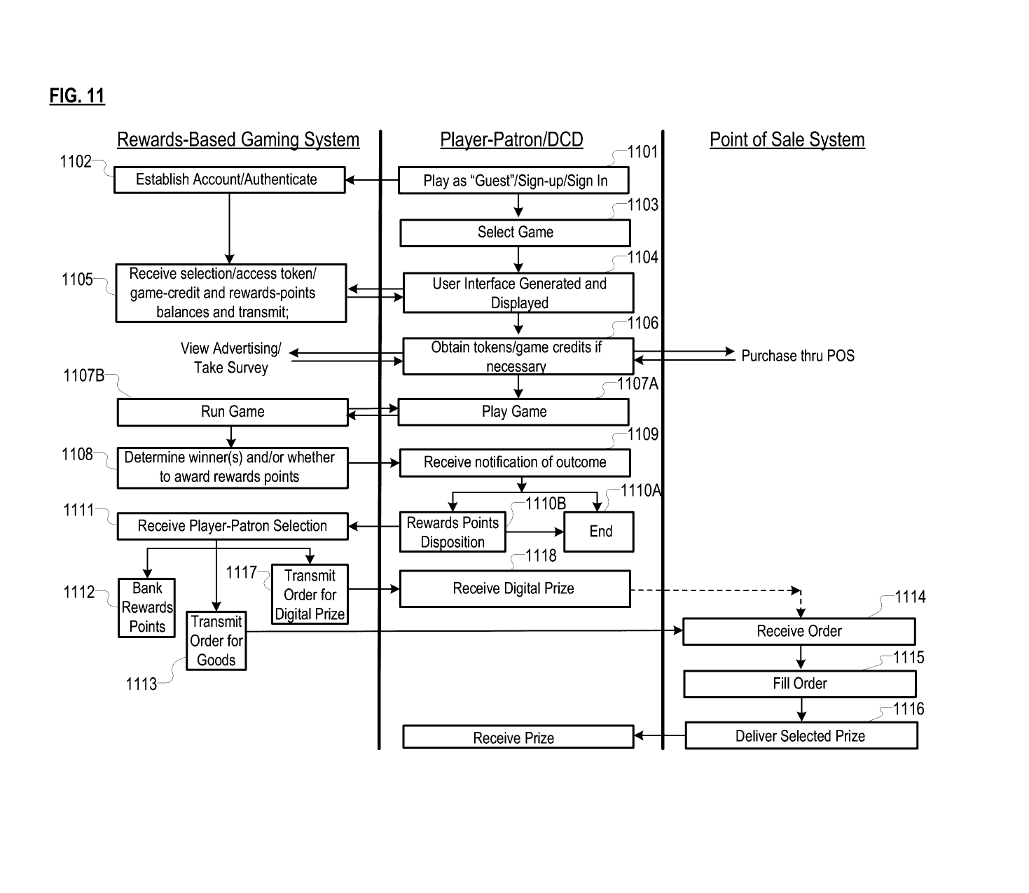

FIG. 11 depicts tasks performed by gaming system 100 implementing a method in accordance with the present invention. In addition to depicting the tasks performed by the gaming system, FIG. 11 depicts tasks performed by the player-patron using a computing device/tablet and the POS of the business establishment where the player-patron is playing the game. In this embodiment, the gaming system is defined to include the gaming server, rewards server, and database server.

Although the tasks are described in a particular sequential order, they can be configured to work in a different order. That is, any particular sequence or order of tasks does not necessarily indicate a requirement that the tasks be performed in that order. The tasks of methods described herein may be performed in any order practical. Further, some tasks can be performed simultaneously.

In task 1101, the player-patron “clicks” on a soft-key, etc., on tablet 102 to access the gaming system. The player-patron is presented with the options of: “signing-in” if already an account holder, “signing-up” if an account is desired, or playing as a “guest”. In task 1102, the gaming system performs appropriate overhead tasks as function of the player-patron's status. For example, in the case of an existing account, the gaming system will authenticate the player-patron and access their account.

In task 1103, the player-patron selects a game (i.e., opens a game application) from options appearing in the display of the tablet. In the illustrative embodiment, the tablet generates a graphical user interface (“GUI”) unique to the selected game and causes it to appear on the tablet's display screen in task 1104. A GUI for use in conjunction with an illustrative embodiment of the invention is discussed further below in conjunction with FIG. 12.

Per task 1105, the gaming system receives the player-patron's game selection, accesses their tokens or game-credits balance and rewards-points balance, if any, and transmits the balances to the tablet for display in the GUI. If necessary, the player-patron is given the opportunity to obtain tokens or game credits in task 1106. Tokens or game credits can be obtained, for example, by purchasing goods offered through the POS of the business establishment or by viewing advertising or taking a survey, as provided by the gaming system.

The game begins, per tasks 1107A or 1107B, with action by the player-patron (entering a command via the GUI) that is transmitted to the gaming system or action by the gaming system (in particular, the game server) that is transmitted to the player-patron's tablet, as a function of the game selected.

For example, a player-patron can play a single-player game, such as a “slots” game. A required amount of tokens (for a game of chance such as “slots”) are debited from the player-patron's account. The player-patron clicks a “SPIN” button that appears in the GUI. The SPIN message is transmitted to the game server in the gaming system. The gaming server determines the outcome of the spin (e.g., via a random-number generator, etc.) and sends information indicative of the outcome to the player-patron's tablet. The tablet spins the reels appearing in the GUI so that they land on the outcome determined by the game server.

In a second example, a player-patron can play a single-player versus house game, such as “blackjack”. The player-patron places a bet and clicks a “DEAL” button that appears in the GUI. The DEAL message is sent to the game server in the gaming system. The game server “draws” initial cards (from a shuffled deck) and transmits the hand (i.e., the identity of the cards that were drawn) to the player-patron's tablet. The tablet displays the cards in the GUI and queries the player-patron to “HIT” or “STAND”. The tablet transmits the response (HIT or STAND) to the game server. If the HIT message is received, the game server draws and transmits another card to the player-patron. This loop continues until the player-patron busts or STANDs. If/when the player stands, the game server plays out the dealer's hand, sending the cards drawn (if any) to the tablet as they are drawn.

In a third example, a player-patron can play a two-player competitive skill game, such as a game like “Boggle®”. A required amount of game credits (i.e., for a game of skill) are debited from the account of each player-patron, or this game could be offered free of charge. The game server generates a random n×n (e.g., 4×4, etc.) game board of letters and transmits it to the table of each player-patron. The player-patrons finds as many words as they can within a given period of time (e.g., 2 minutes, etc.) and those words are transmitted to the game server. The game server determines the winner by comparing the scores of the two player-patrons. The game server then transmits winner/loser information to the tablets of the two player-patrons.

Continuing with the description of the FIG. 11, in task 1108, winner(s)/loser(s) are determined and/or a decision of whether to award rewards points is made and transmitted to the player-patron's tablet. The player-patron receives notification as to outcome and/or whether rewards points have been awarded in task 1109.

If points have not been awarded and if the player-patron has insufficient rewards points to select a prize, then, per task 1110A, processing ends (e.g., the player-patron can choose to play another game or quit playing).

If the player-patron has been awarded rewards point and/or has sufficient rewards points saved to select a prize, a disposition for the rewards points is determined at task 1110B. If the player-patron has been awarded points, but the amount is insufficient for any prize, the rewards points are automatically banked (i.e., accumulated in the player-patron's account) at task 1112 and processing ends (e.g., the player-patron can choose to play another game or quit playing).

If the player-patron has been awarded rewards points and that amount of points is sufficient to acquire a prize, at least some prize options will be displayed in the GUI appearing in the display of player-patron's tablet. As noted earlier, in some embodiments, the prize options being displayed have been filtered by the rewards server of the gaming system, based on various attributes (e.g., location of the player-patron, date/time of day, rewards points balance, demographic data about the player-patron, etc.). In some embodiments, prize options are displayed in the GUI regardless of whether the player-patron has a sufficient point balance to choose such prizes (e.g., see, FIG. 12: image of “lock” appearing in prize window to indicate that insufficient rewards points are available).

If the amount of awarded points is insufficient for a prize of interest, the player-patron will request that the rewards points be banked. The request is received at task 1111 and the points are banked per task 1112. If the player-patron has not been awarded points, but has a sufficient amount of rewards points for a prize, they can submit a request for a prize or choose to play another game, or quit playing.

If the player-patron decides to select a prize (based on newly awarded points, a combination of newly awarded points and accumulated points, or only accumulated points) based from prize options displayed in the GUI, the request is received by the rewards server of the gaming system at task 111.

Subsequent processing depends on the nature of the selected prize. For example, if the player-patron selects goods, as appropriate for the business establishment in which the game was played (e.g., restaurant, casino, hotel: food or drink, merchandise establishment: merchandise, etc.), the rewards server of the gaming system transmits, in task 1113, an order for such goods to the POS of the business establishment. Per task 1114, the POS receives the order and, in task 1115, fills the order within minutes (as a function of food-preparation time, etc.). A service representative of the business establishment then delivers the prize, generally within 30 minutes of the time it was ordered, to the player-patron at the (known) location of the tablet in accordance with task 1116.

Alternatively, if the player-patron has selected a prize that can be electronically delivered, the rewards server transmits an order for the prize, per task 1117, to either the POS of the business establishment at which the player-patron is located or a third-party business establishment. With respect to the former, illustrative prizes include a coupon, discount, or a gift card, all redeemable for goods that can be purchased from the business establishment. As to the latter, an illustrative prize includes a gift card from a credit card company, Amazon®, etc.

In task 1118, the electronic prize is received at the tablet or smart phone of the player-patron. If the prize is a coupon or discount that the player-patron applies soon thereafter to a purchase from the business establishment, an order is transmitted to the POS of the business establishment, which is received, filled, and delivered to the player-patron.

FIG. 12 depicts an illustrative GUI for a slots game that can be played in conjunction with embodiments of the gaming system. As previously described, in the illustrative embodiment, the GUI is generated by specialized software that resides on the computing device/tablet.

The GUI includes “token” icon 1260 and balance window 1262. The player-patron's token balance (i.e., “900” credits in the example) is displayed in balance window 1262. Selecting “GET MORE” soft key 1264 provides the player-patron with options, as previously discussed, for obtaining more tokens. Next to the token balance window is “rewards points” icon 1266 and balance window 1268. The player-patron's rewards points balance (i.e., “0” points in the example) is displayed in balance window 1268. Selecting the “GET REWARDS” soft key 1270 provides the player-patron with options, as previously discussed, for obtaining additional rewards points.

The GUI includes a plurality of reels 1274 (five in the illustrative embodiment), each reel bearing a number of symbols 1276. The player-patron bets a number of tokens in betting window 1280, using the “+” soft key 1282 or “−” soft key 1284 to increment or decrement the bet. The player-patron presses the “SPIN” soft key 1286, which, as discussed earlier, transmits a “spin” command to the game server. The game server determines the outcome of the spin and transmits it back to the tablet, which then spins reels 1274 such they ultimately display the outcome determined by the game server. “GAME OVER” indicator 1289 illuminates to indicate that the game is over.

The outcome of every “spin” of the reels is stored by the gaming system (in a database accessible to the database server). Each spin is assigned an identification number 1288. In the example, that number is “ID 1487”. The player-patron can press “HELP” soft key 1278 for playing instructions.

“JACKPOT” window 1290 provides the current amount of the jackpot in rewards currency (in the example, 250,000 points). Pressing “additional games” soft key 1291 accesses a list of games available for play.

Prize windows 1292 (four are shown) provide the player-patron with prize options. Each window 1292 includes image 1293 (providing an illustration of the prize), cost-to-purchase 1294 (in rewards points), lock icon 1295 (indicating insufficient rewards points balance), and description 1296 (of the prize). Pressing MORE soft key 1297 (associated with the right-most prize window) causes different prize options to be displayed in the first three prize windows 1292.

There are several soft keys at the bottom of the GUI. These soft keys display icons for “flight,” “home,” “food,” “drinks,” and “internet.” When pressed, these soft keys clear the game screen and provide, respectively, flight information, the home page, food menu, drink menu, or access the internet.

The term “non-transitory” is to be understood to remove only propagating transitory signals per se from claim scope and does not relinquish rights to all standard computer-readable media that are not only propagating transitory signals per se.

It is to be understood that the disclosure describes a few embodiments and that many variations of the invention can easily be devised by those skilled in the art after reading this disclosure and that the scope of the present invention is to be determined by the following claims.

What is claimed is:

1. A data processing system for a rewards-based gaming system, the data processing system comprising:
a game application, wherein the game application is resident on a computing device accessible by a user, and wherein the game application generates a graphical user interface (GUI) for playing a game, and further wherein the GUI enables the user to enter commands pertaining to the game;
a gaming server, wherein the gaming server:
(a) provides game-play logic for the game;
(b) determines an outcome of the game in response to the user commands; and
(c) manages three gaming currencies, including tokens, game credits and rewards points;
a rewards server, wherein the rewards server:
(a) maintains an updated list of prizes available to the user and a cost thereof in rewards-points currency;
(b) filters the list of prizes for presentation to the user via the GUI, wherein the filtered list of prizes includes prizes that are physically embodied and prizes that are in electronic form;
(c) manages claiming of a prize from the filtered list;
(d) conducts a prize drawing; and
(e) transmits information to a business establishment for handling prize fulfillment; and
a database server including a plurality of databases, wherein the databases are accessed by the gaming server and the rewards server to update the databases and retrieve information therefrom.

2. The data processing system of claim 1 wherein the rewards server is in communication with a point of sale terminal of the business establishment.

3. The data processing system of claim 1 wherein the tokens are the currency used to play games of chance and game credits are the currency used to play games of skill.

4. The data processing system of claim 1 wherein the rewards server filters the list of prizes based on one or more considerations selected from the group consisting of user location, date, time of day, user rewards points balance, and user demographic information.

5. The data processing system of claim 1 wherein the user is located in the business establishment.

6. The data processing system of claim 1 wherein the user is not located in the business establishment.

7. The data processing system of claim 1 and further wherein the data processing system includes the computing device, wherein the business establishment offers food and drinks for sale, and further wherein the food and drink can be ordered via the computing device and the prize is selected using the computing device.

8. A method for operating a rewards-based gaming system, the method comprising:
generating, on a computing device, a graphical user interface by which a user enters commands to play a game;
receiving, at a data processing system, the commands entered via the user;
processing, at the data processing system, the received commands via game-play logic associated with the game;
transmitting, from the data processing system to the computing device, results of the processing, wherein the results comprise an outcome of the game;
determining, at the data processing system, whether rewards points are issued to the user based on the outcome of the game and, if so, crediting a rewards points account of the user;
transmitting, from the data processing system to the computing device for presentation to the user via the graphical user interface, an amount, if any, of the rewards points issued;
transmitting, from the data processing system to the computing device for presentation to the user via the graphical user interface, a list of prizes for purchase via rewards points;
receiving, at the data processing system from the computing device, a request for one of the prizes; and
transmitting, from the data processing system to a business entity, the request for fulfillment by the business entity.

9. The method of claim 8 and further wherein transmitting the request further comprises transmitting the request to a point of sale system of the business entity.

10. The method of claim 8 and further comprising determining, at the data processing system, whether the user has sufficient game-currency to play the game.

11. The method of claim 8 and further comprising transmitting, from the data processing system to the computing device, a query to the user, wherein the query pertains to whether the user is willing to view an advertisement to obtain game currency.

12. The method of claim 8 and further comprising transmitting, from the data processing system to the computing device, a query to the user, wherein the query pertains to whether the user is willing to take a survey to obtain game currency.

13. The method of claim 8 wherein the list of prizes is a subset of all available prizes, and wherein the list of prizes is generated by filtering all available prizes by one or more considerations selected from the group consisting of a location of the user, a date, a time of day, a rewards-points balance of the user, and user demographic data.

14. The method of claim 8 and further comprising delivering the requested prize to the user.

15. The method of claim 8 and further comprising transmitting the requested prize to the computing device.

16. The method of claim 8 and further comprising determining, at the data processing system, a location of the user.

17. The method of claim 16 and further comprising transmitting, from the data processing system to the business entity, the location of the user.
